(19) United States
(12) Patent Application Publication
(10) Pub. No.: US 2024/0211826 A1
(43) Pub. Date: Jun. 27, 2024

(54) SYSTEM AND METHODS FOR IMPLEMENTING A COMPUTER-BASED MULTI-LINGUAL NATURAL CONVERSATION ENGINE FOR SCREENING JOB APPLICANTS

(71) Applicant: Randstad NV, Diemen (NL)

(72) Inventors: Lukasz Andrzej REWERENDA, Bussum (NL); Glen Evan CATHEY, Tampa, FL (US)

(73) Assignee: Randstad NV, Diemen (NL)

(21) Appl. No.: 18/087,490

(22) Filed: Dec. 22, 2022

Related U.S. Application Data
(60) Provisional application No. 63/293,412, filed on Dec. 23, 2021.

(51) Int. Cl. G06Q 10/0631; G06F 40/58; G06Q 10/1053; H04L 51/02

(52) U.S. Cl. CPC G06Q 10/063112; G06F 40/58; G06Q 10/1053; H04L 51/02

(57) ABSTRACT

Provided herein are systems and methods for implementing a multi-lingual natural language conversation engine is provided that is configured to conduct an interview with a job applicant. In one or more examples, the “chatbot” can be configured to replicate human performance during an interview, by ensuring that the candidate is provided with context appropriate questions, and can communicate with the applicant in a manner that automates the interview process thus reducing time and effort spent on the interviewing process, while making the process indistinguishable from a real human interviewer.

### CROSS-REFERENCE TO RELATED APPLICATION

This application claims the benefit of U.S. Provisional Application No. 63/293,412, filed Dec. 23, 2021, the entire contents of which is incorporated herein by reference.

### FIELD

This disclosure relates to implementing a computer-based multi-lingual natural language conversation engine that can communicate with one or more job applicants to conduct screening interviews with the applicants with little to no human intervention during the interview.

### BACKGROUND

Finding and hiring the right employees for an organization can be a time-consuming and expensive process. Often times an organization looking to hire for a certain position can be inundated with resumes from many applicants, some of which may be qualified, and some that are not. Even after sifting through the received applications, an employer can be required to then contact potential matches to perform a phone screen or other interview, to ensure that the candidate is suitable for the job, and to ensure that the position is suitable to the candidate. After the initial screening interview, and only if there is a promising match between the employer's expectations and the candidates expectations, the candidate can be invited to do a formal interview to determine suitability for a position within an organization.

As demonstrated above, even the process of choosing which candidates to bring in for a formal interview (let alone actually select to hire) can be a time-consuming process requiring an organization to expend considerable time and expense sifting through an untold number of resumes, selecting promising candidates for initial phone screen interviews, and then finally conducting a formal interview to ultimately make a hiring decision.

One way to reduce the amount of human effort required to weed through and vet potential hires is to automate as much of the process of possible. For instance, resumes can be optically scanned and searched to ensure that candidates possess the requisite level of schooling and/or experience for a given position. However, even if resumes are automatically screened without requiring human intervention, the number of resumes left after this initial screening may be large, meaning that the process of performing screening interviews for each and every qualified resume will be a time-intensive and human labor intensive process, requiring that one or more employees at an organization or a staffing firm contracted to help find qualified candidates may have to conduct a large number of interviews, thereby using considerable resources and time to complete the interview process.

Automating all or part of the screening interview or even the formal interview process can go a long way towards reducing the time, expense and effort, involved in hiring qualified candidates for a job opening. For instance, rather than dedicating one or more persons to meet with potential hires, a company can instead employ a software application that can be used to conduct an “on-line” chat with a potential candidate to determine suitability for a job opening. A “chatbot” can be employed to automate the screening process, but in order to be used as an effective tool, the chatbot must replicate human performance during an interview. For instance, the chatbot should speak with a candidate much like a human would and should conduct an interview in substantially the same manner as a human would.

What is needed is a chatbot that can simulate natural human language while also being capable of conducting a logically flowing interview with a candidate taking into account certain contexts such as the interviewees resume and answers to questions to formulate future questions that are directed to extracting information for a candidate's suitability for a particular position. In order to replicate human performance when acting as an interviewer, the chatbot should be configured to ask questions of interviewee that are context appropriate and logically flow as a natural conversation with the goal of not being distinguishable from a real “human” interviewer.

### SUMMARY

According to an aspect, systems and method for implementing a multi-lingual natural language conversation engine is provided that is configured to conduct an interview with a job applicant is provided. In one or more examples, the “chatbot” can be configured to replicate human performance during an interview, by ensuring that the candidate is provided with context appropriate questions and can communicate with the applicant in a manner that makes it nearly indistinguishable from a real human interviewer.

In one or more examples, the chatbot can include a translator that is configured to receive human input (in the form of text or voice for example) and can then translate the received input into one or more languages for use by the chatbot. In one or more examples, the chatbot can include a comprehension engine that can employ one or more machine learning classifiers that are configured to determine one or more intents from the user's input. In one or more examples, the machine learning classifiers can be generated using a supervised training method.

In one or more examples, the chatbot can guide the conversation between itself and a user using a business logic decision tree that uses the classified intent of the user's speech to navigate the tree so as to direct the flow of a conversation between the chatbot and the user. In one or more examples, the chatbot can apply a human-resources (HR) intelligence process to the business-logic tree, to prune or trim away portions of the tree based on the specific context of the user and its interaction with the chatbot. For instance, using the user's resume and the details of the position they are applying for, the HR intelligence process can remove portions of the tree that would not make sense in the context of the user's qualifications (i.e., based on their resume) as well as the context of the position that the user is applying for.

In one or more examples, the system and methods can include a contextual intelligence component that can refine the navigation of the tree during a chatbot session to not only use the identified intents of the user's response, but other contextual information to make decisions about how to traverse the business logic tree. In one or more examples, once the chatbot determines the next question to ask an applicant, the chatbot can also employ an attitude detection and adjustment tool and a repetition avoidance tool to ensure that the way in which the questions communicated to the applicant are being present is suited to the user's detected attitudes towards the questioning and is configured to avoid repetition in speech thus making the chatbot more human-like in the way in interacts with the applicant. In one or more examples, once the chatbot determines the precise question to ask a user, the question can be translated into the applicant's language of choice and then relayed back to the user of the chatbot (i.e., the applicant).

In one or more examples, a method for implementing a computer-based chatbot to conduct an employment interview with a candidate for a position within a client organization comprises: receiving one or more requirements of the position within the client organization, receiving from the candidate, information associated with candidate's qualifications for the position, generating a plurality of block data structures stored in a memory, wherein the plurality of block data structures form a graph with each block data structure representing a node of the graph, wherein each block of the plurality of block data structures includes a topic data parameter and a prompt data parameter, the topic data parameter storing data associated with a topic of conversation between the chatbot and the user and the prompt data parameter storing information associated with one or more questions to ask the user pertaining to the topic data parameter; and wherein the plurality of block data structures are generated based on the received one or more requirements of the position within the client organization and the received information associated with the candidate's qualifications for the position, transmitting a question from the chatbot to the user based on the topic data parameter and the prompt data parameter associated with a first block data structure of the plurality of block data structures, receiving at the chatbot, one or more responses to the transmitted question from the user, determining one or more intents of the one or more responses from the user, and transmitting a question from the chatbot to the user based on the topic data parameter and the prompt data parameter associated with a second block data structure of the plurality of block data structures; wherein the second block data structure is selected based on the determined one or more intents of the one or more responses from the user.

Optionally, generating the plurality of block data structures includes selecting a template from a plurality of templates based on the received one or more requirements of the position, wherein each template includes one or more pre-defined block data structures.

Optionally, method comprises removing one or more pre-defined block data structures from the plurality of block data structures of the selected template based on the received one or more requirements of the position and the received information associated with the candidate's qualifications for the position.

Optionally, method comprises modifying one or more prompts of the plurality of block data structures based on the received one or more requirements of the position and the received information associated with the candidate's qualifications for the position.

Optionally, the method comprises comparing the determined one or more intents of the one or more responses from the user to a list of one or more expected intents associated with the first block data structure.

Optionally, the method comprises if the determined one or more intents of the one or more responses from the user do not match the one or more expected intents associated with the first block data structure, then selecting the second block data structure based on the topic data parameter of the first block data structure and the determined one or more intents.

Optionally, the method comprises modifying the prompt data parameter of the second block data structure based on the topic data parameter of the first block data structure and the determined one or more intents of the one or more responses from the user.

Optionally, transmitting a question from the chatbot to the user based on the topic data parameter and the prompt data parameter associated with a first block data structure of the plurality of block data structures comprises determining an attitude of the user based on the one or determined intents of the user and modifying the transmitted question based on the determined attitude of the user.

Optionally, determining the one or more intents of the one or more responses from the user comprises applying a machine learning classifier to the one or more responses from the user.

Optionally, the machine learning classifier is generated using a supervised training process.

In one or more examples, a system for implementing a computer-based chatbot to conduct an employment interview with a candidate for a position within a client organization comprises: a memory, one or more processors, wherein the memory stores one or more programs that when executed by the one or more processors, cause the one or more processors to: receive one or more requirements of the position within the client organization, receive from the candidate, information associated with candidate's qualifications for the position, generate a plurality of block data structures stored in a memory, wherein the plurality of block data structures form a graph with each block data structure representing a node of the graph, wherein each block of the plurality of block data structures includes a topic data parameter and a prompt data parameter, the topic data parameter storing data associated with a topic of conversation between the chatbot and the user and the prompt data parameter storing information associated with one or more questions to ask the user pertaining to the topic data parameter; and wherein the plurality of block data structures are generated based on the received one or more requirements of the position within the client organization and the received information associated with the candidate's qualifications for the position, transmit a question from the chatbot to the user based on the topic data parameter and the prompt data parameter associated with a first block data structure of the plurality of block data structures, receive at the chatbot, one or more responses to the transmitted question from the user, determining one or more intents of the one or more responses from the user, and transmit a question from the chatbot to the user based on the topic data parameter and the prompt data parameter associated with a second block data structure of the plurality of block data structures; wherein the second block data structure is selected based on the determined one or more intents of the one or more responses from the user.

Optionally, generating the plurality of block data structures includes selecting a template from a plurality of templates based on the received one or more requirements of the position, wherein each template includes one or more pre-defined block data structures.

Optionally, the one or more processors are caused to remove one or more pre-defined block data structures from the plurality of block data structures of the selected template based on the received one or more requirements of the position and the received information associated with the candidate's qualifications for the position.

Optionally, the one or more processors are caused to modify one or more prompts of the plurality of block data structures based on the received one or more requirements of the position and the received information associated with the candidate's qualifications for the position.

Optionally, the one or more processors are caused to compare the determined one or more intents of the one or more responses from the user to a list of one or more expected intents associated with the first block data structure.

Optionally, the one or more processors are caused to if the determined one or more intents of the one or more responses from the user do not match the one or more expected intents associated with the first block data structure, then selecting the second block data structure based on the topic data parameter of the first block data structure and the determined one or more intents.

Optionally, the one or more processors are caused to modify the prompt data parameter of the second block data structure based on the topic data parameter of the first block data structure and the determined one or more intents of the one or more responses from the user.

Optionally, transmitting a question from the chatbot to the user based on the topic data parameter and the prompt data parameter associated with a first block data structure of the plurality of block data structures comprises determining an attitude of the user based on the one or determined intents of the user and modifying the transmitted question based on the determined attitude of the user.

Optionally, determining the one or more intents of the one or more responses from the user comprises applying a machine learning classifier to the one or more responses from the user.

Optionally, the machine learning classifier is generated using a supervised training process.

In one or more examples, a non-transitory computer readable storage medium storing one or more programs for implementing a computer-based chatbot to conduct an employment interview with a candidate for a position within a client organization, for execution by one or more processors of an electronic device is provided that when executed by the device, cause the device to: receive one or more requirements of the position within the client organization, receive from the candidate, information associated with candidate's qualifications for the position, generate a plurality of block data structures stored in a memory, wherein the plurality of block data structures form a graph with each block data structure representing a node of the graph, wherein each block of the plurality of block data structures includes a topic data parameter and a prompt data parameter, the topic data parameter storing data associated with a topic of conversation between the chatbot and the user and the prompt data parameter storing information associated with one or more questions to ask the user pertaining to the topic data parameter; and wherein the plurality of block data structures are generated based on the received one or more requirements of the position within the client organization and the received information associated with the candidate's qualifications for the position, transmit a question from the chatbot to the user based on the topic data parameter and the prompt data parameter associated with a first block data structure of the plurality of block data structures, receive at the chatbot, one or more responses to the transmitted question from the user, determining one or more intents of the one or more responses from the user, and transmit a question from the chatbot to the user based on the topic data parameter and the prompt data parameter associated with a second block data structure of the plurality of block data structures; wherein the second block data structure is selected based on the determined one or more intents of the one or more responses from the user.

Optionally, generating the plurality of block data structures includes selecting a template from a plurality of templates based on the received one or more requirements of the position, wherein each template includes one or more pre-defined block data structures.

Optionally, the device is caused to remove one or more pre-defined block data structures from the plurality of block data structures of the selected template based on the received one or more requirements of the position and the received information associated with the candidate's qualifications for the position.

Optionally, the device is caused to modify one or more prompts of the plurality of block data structures based on the received one or more requirements of the position and the received information associated with the candidate's qualifications for the position.

Optionally, device is caused to compare the determined one or more intents of the one or more responses from the user to a list of one or more expected intents associated with the first block data structure.

Optionally, the device is caused to if the determined one or more intents of the one or more responses from the user do not match the one or more expected intents associated with the first block data structure, then selecting the second block data structure based on the topic data parameter of the first block data structure and the determined one or more intents.

Optionally, the device is caused to modify the prompt data parameter of the second block data structure based on the topic data parameter of the first block data structure and the determined one or more intents of the one or more responses from the user.

Optionally, wherein transmitting a question from the chatbot to the user based on the topic data parameter and the prompt data parameter associated with a first block data structure of the plurality of block data structures comprises determining an attitude of the user based on the one or determined intents of the user and modifying the transmitted question based on the determined attitude of the user.

Optionally, determining the one or more intents of the one or more responses from the user comprises applying a machine learning classifier to the one or more responses from the user.

Optionally, the machine learning classifier is generated using a supervised training process.

### BRIEF DESCRIPTION OF THE FIGURES

The invention will now be described, by way of example only, with reference to the accompanying drawings, in which:

FIG. 1 illustrates an exemplary hiring process according to examples of the disclosure.

FIG. 2 illustrates an exemplary interview chatbot system according to examples of the disclosure.

FIG. 3 illustrates an exemplary supervised training method for generation one or more machine learning classifiers configured to determine intent from a user's speech according to examples of the disclosure.

FIG. 4 illustrates an exemplary business logic decision tree according to examples of the disclosure.

FIG. 5 illustrates an exemplary process for generating a business logic decision tree according to examples of the disclosure.

FIG. 6 illustrates an exemplary process for applying contextual intelligence to a business logic tree according to examples of the disclosure.

FIG. 7 illustrates an exemplary computing system, according to examples of the disclosure.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Described herein are systems and methods for implementing a computer-based chatbot to conduct an employment interview with a candidate for a position within a client organization. In one or more examples, the computer system can receive a listing of requirements for the position from the client organization and can also receive a candidate's qualifications in the form of a curriculum vitae (CV). Using the list of requirements and the candidate's CV, the system can generate a business logic tree that is used by the chatbot to guide the conversation and provide the chatbot with questions to ask the candidate during the interview.

According to an aspect, the business logic tree can be generated by selecting a template based on the requirements for the position, and then prune the tree (i.e., remove blocks) based on the received requirements and qualifications. In one or more examples, the business logic tree can include one or more block data structures that are interconnected with one another to form a graph structure. Each block of the graph can include a topic data parameter that provides the topic of conversation associated with the block as well as a prompt data parameter that instructs the chatbot as to what to say to the user in order to extract information from the user (i.e., candidate) pertaining to the topic data parameter. In one or more examples, the candidate provides an answer to questions posed by the chatbot. The received answer is then processed by one or more machine learning classifiers that extract the intent of the user's response. Based on the extracted intent, the chatbot decides which block data structure of the graph to move to next, as well as store's the information provided by the user's answers in a memory. In one or more examples, the business logic tree can be modified by modifying the prompt data parameter based on the context of the conversation, which can include both the job requirements of the client organization and the user's CV.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations described herein. This device may be specially constructed for the required purposes, or it may comprise a general-purpose computer selectively activated or reconfigured by a computer program stored in the computer. Such a computer program may be stored in a non-transitory, computer readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs. In one or more examples, the systems and methods presented herein, including the computing systems referred to in the specification may be implemented on a cloud computing and cloud storage platform.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the present disclosure as described herein.

Hiring the right employees for a particular job can be a time-consuming endeavor. Conventionally, the process begins by posting a job advertisement in a printed publication or web publication describing the requirements of the position. In response to the advertisement or job posting, those interested in the job can submit their resume (i.e., curriculum vitae (CV)) listing their credentials and other information in hopes obtaining the job.

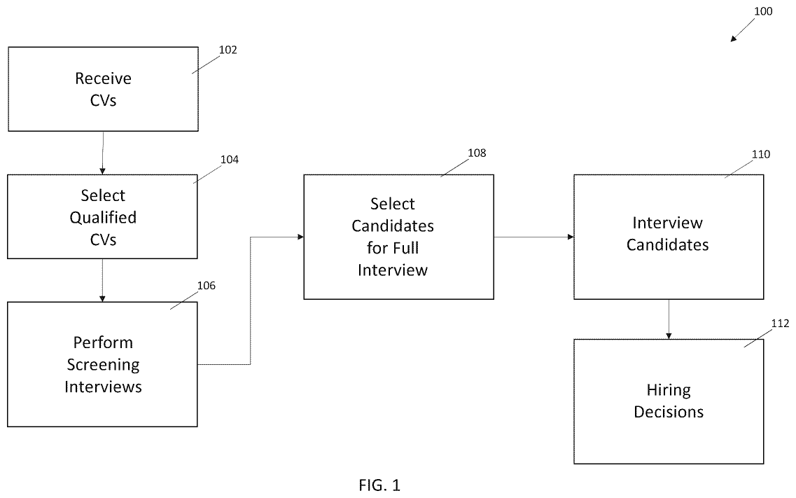

FIG. 1 illustrates an exemplary hiring process according to examples of the disclosure. In one or more examples, the process 100 can begin at step 102 wherein in response to a job posting, or even unsolicited, an employer or staffing agency can receive one or more CVs with the purpose of filling one or more open jobs within an organization. In one or more examples, the employer or staffing agency may receive thousands of CVs for a single job opening, which as described above can make the process of selecting a qualified candidate time and resource consuming. Once all of the CVs have been received at step 102, the process 100 can move to step 104 wherein the received CVs are reviewed to select one or more CVs from job applicants that appear suitable for the position to be filled. In one or more examples, and in the case where thousands of CVs are received for a given job opening, the step of selecting qualified CVs at step 104 can involve, looking at the CVs to determine whether a candidate looks to have the requisite level of experiences and skillsets that are correlated with the needs of the job. In one or more examples, selecting qualified candidates can require that the decision maker understand the needs of the position to be filled, and then use that knowledge to review the CVs to see if there is a potential match between the skills listed in the CV and the job to be filled. In the event that there are numerous CVs to review, the process of selecting qualified CVs can take a great deal of time, even in the event that a CV can be reviewed within seconds to determine if there is a suitable match.

In one or more examples, once the qualified CVs have been selected at step 104, the process 100 can move to step 106, wherein screening interviews are performed with the job candidates corresponding to the CVs selected at step 104. The purpose of the screening interview is to gather more information from the candidate regarding their qualifications, as well as asking the candidate questions relating to their preferences to see if the candidate is suitably matched to the requirements of the job for which they are applying. The purpose of the screening interview is to take an initial look at the qualifications of a candidate and to make sure that at a high-level the candidate and the job are suitably matched to one another. In one or more examples, the screening interview held at step 106 may be facilitated by a staffing agency or human resources department within an organization due to the fact that the interviewer may not need to have intimate knowledge of the job for which they are hiring but may only be required to know the requirements of the job at an abstract or high level.

As will be discussed in further detail below, the screening process can consume a great deal of resources. For instance, if many CV are selected at step 104, then at step 106, a staffing organization or human resources department within a company may be required to conduct thousands of screening interviews. Conventionally, since screening interviews are conducted with human interviewers, the process of performing a single screening interview can tie up resources and time, making the process expensive. Furthermore, since conventionally a human interviewer is used to perform a screening interview, the ability to interview potential candidates in parallel with another may be limited or not possible since an interviewer can only conduct a single interview at a time. The inability to conduct interviews in parallel can mean that the process of performing the screening interviews may take a long time since each interview would have to be conducted serially, one at a time. Alternatively, the staffing agency or HR department could employ multiple interviewers who can interview candidates in parallel so as to shorten the amount of time it would take to go through all of the candidates whose CVs were selected at step 104. However, using multiple interviewers can be an expensive option to shorten the screening time, since it would require hiring and paying multiple persons to perform the task.

In one or more examples, once the screening interviews are conducted at step 106, the process 100 can move to step 108 wherein the staffing agency or HR department can select one or more candidates for full interviews that generally take place with the organization or departments within an organization who are trying to fill the position. In one or more examples, step 108 can include reviewing the answers to the questions asked during the screening interview at step 106 and the responses to determine which candidates are best suited for the position, and thus should be passed along to the full interview process.

In one or more examples, once the candidates have been selected for a full interview at step 108, the process 100 can move to step 110 wherein the remaining candidates are interviewed, usually by one or more persons within and organization who are intimately familiar with the position to be filled. Finally, once the remaining candidates have been interviewed at step 110, the process 100 can move to step 112 wherein one or more hiring decisions are made. In the example of process 100, and in the event that single applicant will be selected for a given job opening, the process can start with thousands or more CV at step 102 and conclude with the hiring of a single candidate at step 112. The number of resources required to move from thousands of candidates to a single candidate hired can be large and thus can cause the hiring process to impede the ability of an organization to obtain qualified talent.

In one or more examples, in order to minimize the resources required to fill an open job position, one or more of the steps defined in the process 100 can be automated so as to minimize the resources needed to fill a given position. For instance, step 104 can be automated, by having the CVs received at step 102 scanned by computing system for keywords associated with the skills that a particular position requires and selecting only the CVs in which particular keywords or skills are found. However, even automating step 104 may not be enough, because the most time and labor-intensive step in the hiring process may be conducting the screening interviews at step 106. Selecting qualified CVs at step 104 may still yield a large number of candidates, and in order to prescreen the applicants that were selected, a staffing agency or human resources department will have to deploy interviewers and time to conducting thousands of interviews to winnow down the list of candidates to a number that is feasible for performing full interviews with an organization for filling a particular open job requisition.

In one or more examples, automating the screening process can lead to significant savings in both time and the resources required to perform the screening process. As described above, the screening process can require either one or a few people to interview thousands of candidates serially or can require the staffing agency or HR department within an organization to employ thousands of screeners to perform the interviews in parallel. However, automating the screening process, by substituting a computing system for the human interviewer, can allow for the screening interview process to be conducted in parallel with thousands of candidates without requiring the deployment of human capital to achieve a quick screening process.

However, automating the screening process can come with its own challenges. For instance, in one or more examples, a computing system can be used to conduct the interview, posing questions to the candidate, and fielding questions from the candidate, just a human interviewer would in a conventional screening interview. However, as the screening interview is a process to extract further information from the candidate about their qualifications, the interview is also an opportunity for candidates to ask questions about the position they are seeking to ensure that the job is what they are a looking for. Thus, rather than a one-way extraction of information, the screening interview can stand as a two-way conversation, and often can represent the first contact that a candidate has with an organization, thus representing a first impression for the candidate of the company which they are seeking to become a part of.

Thus, using computer automation to automate the screening interview should take care to not diminish the quality of interaction between the candidate and the organization during the screening interview. In one or more examples, a “chatbot” (i.e., an automated computer implemented natural language engine) can be used to conduct a screening interview with a candidate. In one or more examples, the chatbot can automatically formulate questions to ask a candidate based on the requirements of the position to be filled, the candidate's qualifications, as well as the responses given by the applicant during the interview. In one or more examples, the chatbot can be configured to interact with the candidate in a manner that makes the chatbot indistinguishable from a human interviewer. As will be described in further detail below, the chatbot can use context specific intelligence to direct the flow of conversation between a candidate and the chatbot, as well as present the questions to the interviewee in a manner that is responsive to the interviewee's answers to the questions during an interview so as to provide the interviewee with an efficient and effective interview experience.

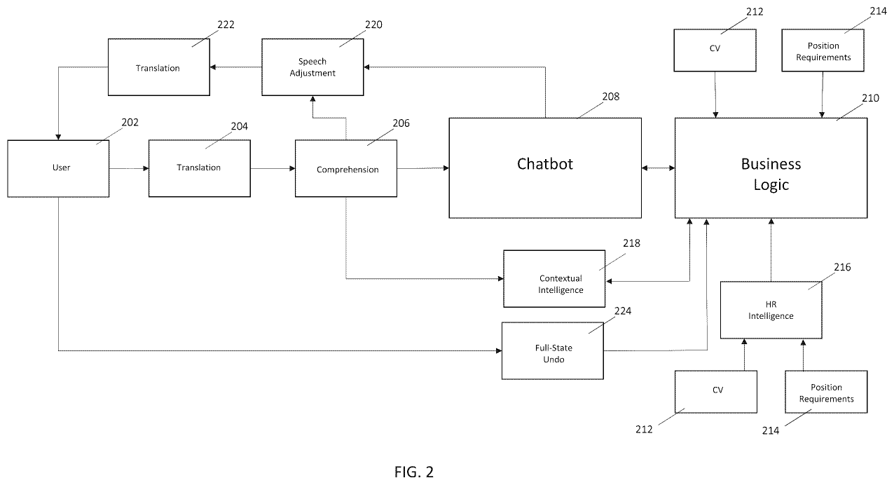

FIG. 2 illustrates an exemplary interview chatbot system according to examples of the disclosure. In one or more examples, the chatbot system illustrated in FIG. 2 can include a plurality of features and components that are collectively configured to conduct an efficient interview process with a candidate, while at the same replicating the experience that an interviewee would have during an interview with a live person. Thus, in one or more examples, the system 200 depicted in FIG. 2 can be configured to guide a flow of discussion between the candidate and the chatbot in a manner that is designed to extract the necessary information from the interviewee in a manner that mimics a natural conversation, and tailors its questioning (including its chosen words) based on the natural flow and tone of the conversation.

In one or more examples, the computing system 202 can be implemented as a distributed software program that is executed on one or more processors located on a server or other computing device. In one or more examples, the computing system 200 can be implemented using a cloud computing resource. The example of computing system 200 is presented herein as a plurality of components in a block diagram, however it should be understood that the components can represent software that resides on one or more processors configured to perform certain functions and processes as outlined in further detail below.

In one or more examples, the system 200 can be configured to interface with a user 202. In one or more examples, the user can interface with the system 200 using a personal computer or mobile device. In one or more examples, the user 202 can communicate with the computing system by entering text into the computing system. Additionally, or alternatively, the user 202 can provide input to the system 200 through voice that can be captured using a microphone or other electronic device capable of recording and storing human speech. In one or more examples, and will be described further below, the user 202 can receive data from the system 200 in the form of text or voice. For instance, in one or more examples, the computing system 200 can employ a chatbot 208 that can receive inputs from the user and provide outputs to the user, so as to engage the user 202 in a conversation using either text or speech as discussed in more detail below.

In one or more examples, the input provided by user 202 can first be received by the computing system 200 using a translator 204. In one or more examples, the translator 202 can receive the text or voice from a user 202 in the language spoken by the user 202 and translate it into a language that is understood by the chatbot 208. For example, if the user enters text to the system in Mandarin or Spanish, the chatbot may not be able to understand those inputs. Therefore, the translator 204 can take the user's input in a first language and translate into a language such as English that can be understood by the chatbot 208. As will be discussed below, the translation can be especially important to understanding the intent of a given user's speech which is done using one or more machine learning classifiers. Thus, translating the user's input can be important for ensuring that the classification of their intents is properly performed by the system 200. In one or more examples, the translator 204 can benefit the chatbot 208 by reducing the complexity of the chatbot. For instance, in one or more examples, the chatbot can be configured in a single language, rather than having to account for all possible languages that the user could speak.

In one or more examples, after the user's input is translated using the translator 204, the translated input can be transmitted to a comprehension engine 206 configured to determine the user's intent behind the text or utterances provided by the user to the system 200. A user's “intent” can be characterized as the meaning and/or sentiment that that the user wishes to convey through the words they choose in response to a certain question or set of questions. Thus, rather than simply taking an action based on the words or utterances submitted to the chatbot 208 by the user 202, the system 200 seeks to understand the intent conveyed by the user based on the words submitted to the system to classify what the intent the user had when speaking the words.

In one or more examples, intents can include informational intents such as answering a question in the affirmative or negative but can also include user sentiments. For instance, in one or more examples, if a user reacts to a question by asking “Why do you need to know?” while from a purely grammatical standpoint the question seems to be a request for more information, the underlying intent of the question can signify that the user is hostile to the question or doesn't wish to answer the question. As will be described in further detail below, a machine classifier can be used to classify the intents of a user's inputs into the chatbot and can be trained using various training phrases to understand the intent of the phrase. Thus, even if the user instead of asking “Why do you need to know?” instead says “Why are you asking?” or “Is this really necessary,” the comprehension engine 206 may classify each of those phrases as having the same intent. Alternatively, the user may actually provide the requested information, and the comprehension engine 206 will also be able to ascertain the intent of the answer as answering the question, and the type of information provided by the user.

In one or more examples, the comprehension engine 206 can include a plurality of machine classifiers, with each classifier trained to classify a phrase or input by a user as belonging to the intent associated with classifier. In one or more examples, each machine learning classifier of comprehension engine 206 can be used to determine the likelihood that a given user input is expressing the intent that the machine classifier is trained to detect. In one or more examples, each machine classifier of the comprehension 206 can be generated using a supervised training process as described in detail below. The input to each machine learning classifier can be the input provided by the user, and the output of the machine learning classifier can be a likelihood that the user meant to express the intent associated with the machine learning classifier.

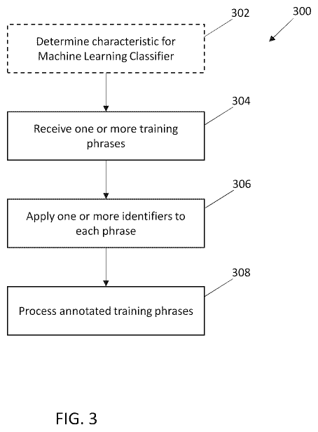

FIG. 3 illustrates an exemplary supervised training method for generation of one or more machine learning classifiers configured to determine intent from a user's speech according to examples of the disclosure. In one or more examples, the process 300 of FIG. 3 can be used to generate a machine learning classifier that is used to determine if a given user input is associated with the intent associated with the machine learning classifier. In one or more examples, the process 300 can begin at step 302 wherein a characteristic (i.e., intent) is determined for a particular machine learning classifier. In one or more examples, the intents can be selected based on the intents that would be expected to be received in a job interview context. For instance, in one or more examples, the intents can include affirmative or negative answers, qualification intents, biographic data intents (i.e., years of experience, age, education), and any other intents that could be expressed by a user in the context of a job interview. In one or more examples, step 432 can be optional, as the selection of characteristics needed to for the machine learning classifiers can be selected beforehand in a separate process. In one or more examples, once a specific intent is selected for a given machine classifier at step 302, the process 300 can move to step 304 wherein one or more training phrases corresponding to the selected characteristics are received. In one or more examples, each training phrase can include one or more identifiers that identify the intents contained within a given phrase. The identifiers can take the form of annotations that are appended to the metadata of the phrase, identifying what intent or intents are contained within the phrase. A particular phrase of the training phrase set can include multiple identifiers.

In one or more examples, if the training phrases received at step 304 do not include identifiers, then the process can move to step 306 wherein one or more identifiers are applied to each phrase of the one or more training phrases. In one or more examples, the training phrases can be annotated with identifiers using a variety of methods. For instance, in one or more examples, the training phrases can be manually applied by a human or humans who view each training phrase, determine what intents are contained within the phrase, and then annotate the phrase with the intents pertaining to those phrases. Alternatively, or additionally, the training phrases can be harvested from phrases that have been previously classified by a machine classifier. For instance, once a machine learning classifier makes a determination as to the intents contained within a previous user input, the previous user input can be annotated with the identified intents (i.e., annotated with one or more identifiers) and the user input can then be transmitted to and stored in a memory for later use as a training phrase. In this way, each of the machine learning classifiers can be constantly improved with new training data (i.e., by taking information from previously classified phrases) so as to improve the overall accuracy of the machine learning classifier. Once each training phrases has one or more intents annotated to the image at step 306, the process 400 can move to step 308 wherein the one or more training phrases are processed by each of the machine learning classifiers in order to train the classifier.

Returning to the examples of FIG. 2, once the user's intent is classified by the comprehension engine 206, the user input and the classified intent of that input can be transmitted to a chatbot 208. In one or more examples, chatbot 208 represents the interface between user and the business logic 210 (described in further detail below). In one or more examples, the chatbot 208 receives user inputs and other data, and transmits either speech or text back to the user 202, thereby providing a back-and-forth conversation with the user in a given session. In the context of a job interview, the chatbot 208 relays questions to the user 202 (based on the business logic 210 described in further detail below), and fields the answers provided by the user 202. The chatbot is provided what to say to a user by a business logic process 210, which instructs the chatbot 208 what to say to a user based on various attributes of the interview, and a conversation flow dictated by parameters that are maintained within the business logic data structures. In one or more examples, the business logic 210 guides the flow of the conversation between the chatbot 208 and the user 202 so as to provide the user 202 with a human-like conversation, while at the same time formulating questions and ordering the questions to maximize the amount of information extracted for a user 202 for the purposes of determining if the user is suitable for a given position within an organization.

In one or more examples, business logic 210 can use a tree or graph type data structure to regulate the flow and content of a conversation between the chatbot 208 and user 202. For instance, in one or more examples, the business logic 210 uses the tree structure to keep track of the current state of the conversation, and makes decisions about what questions to ask next, and how to ask certain questions based on the user's responses to the questions and other factors discussed in further detail below. In one or more examples, the graph data structure of the business logic 210 can use one or more blocks which can act as nodes within the graph data structure, with nodes interconnected to one another via one or more edges. The business logic 210 uses the graph/tree structure as a navigation tool to guide the conversation between the chatbot 208 and the user 202 as described in further detail below.

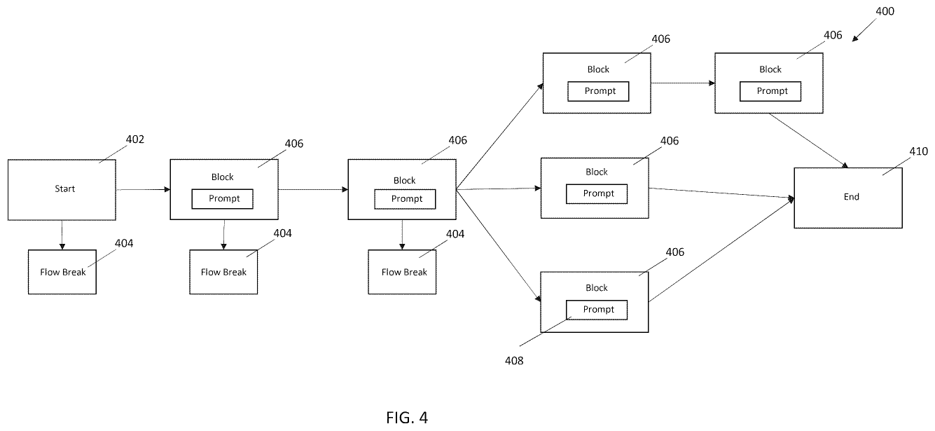

FIG. 4 illustrates an exemplary business logic decision tree according to examples of the disclosure. In one or more examples, the business logic tree 400, can include one or more blocks that can represent the nodes (i.e., leaves) in the tree structure. As shown in FIG. 4, the business logic tree 400 can include four types of blocks: (1) start block 402; (2) one or more regular blocks 406; (3) one or more flow break blocks 404; and (4) an end block 410. In one or more examples, each of the blocks described above can be used by the business logic 210 to control the flow of a conversation. The configuration of the blocks informs the system 200 of FIG. 2 as to which block (i.e., conversation topic) to go to next (and under which conditions). For instance, a connection between any two blocks in the tree 200 can represent a flow of the conversation from a first topic to a second topic. Furthermore, each block can include one or more parameters that define the conditions for which it will transition to another block.

In one or more examples, each block of the business logic tree 400 can include a prompt data parameter 408. While the blocks themselves can include a topic data parameter which tells the chatbot 208 the topic associated with the block, the blocks can also inform the chatbot about the flow of the conversation, such as which block to go to next and under what conditions, when to skip a block, etc., the prompts 408 contained within each block inform the chatbot 208 what to say during the processing of each block. Alternatively, or additionally, the prompts 408 of each block can also provide information about what the expected sent of intents are (i.e., what the system 200 thinks the user will reply with in response to the one or more questions associated with a block) and can also inform the system 200 how to process the responses as they are received.

In one or more examples, each block can be represented in a software program as a data structure. The block data structure can include the general parameters of the block including the conditions for transitioning to other blocks, and parameters associated with received intents from the users 202 in response to questions asked. Optionally, each prompt can also indicate what to say in case of unexpected answers for the user. For instance, in one or more examples, if the user's reply to a question from a particular prompt within the block data structure is not within the expected set of intents for a given block/prompt, then in one or more examples, the prompt can include responses to give the user in the event that the determined intent of the user (as determined by the comprehension engine 206) does not match one of the expected intents that is stored within the prompt 408 for a given block. In one or more examples, each of the blocks described above (i.e., start block 402, flow break block 404, regular block 406, and end block 410) can each have their own prompts associated with them. In one or more examples, the relation between block and prompts can be 1:1 as in every block of the conversation has its own unique prompt definition, and a given prompt associated with a particular block will not be reused elsewhere in business logic tree 200 with respect to other blocks. In this way, the business logic tree 400 is configured to avoid repetition, thus making the conversation with the user that results from use of the tree sound more human-like and less robotic.

An example can help to describe how the blocks and prompts in a business logic tree 200 work with another to guide the flow and content of a conversation between a chatbot 208 and user 202. The business logic tree 400 can begin with a start block 402 that can include its own prompt 408. In one or more examples, the prompt 408 of start block 402 can include certain pleasantries and introductory discussion that the chatbot 208 can provide to the user to begin the interview. In one or more examples, the prompt 408 associated with the start block 402 can also include a question asking the user if they agree to being interviewed by the chatbot. In one or more examples, if the user provides an answer stating that they aren't, then in one or more examples, the prompt of the start block 402 can be configured to register the user's disagreement and move to flow break block 404. In one or more examples, a flow break block 404 can be configured to react to unexpected events in the conversation. For instance, if the user provides a response that doesn't align with one of the expected intents associated with the prompt 408 of a particular block, the chatbot 206 can transition to the flow break block 408 to provide a response to the unexpected event, and even work to terminate the interview on the basis of the user's response. For instance, if the user 202 does not agree to be interviewed using a chatbot, that can trigger a transition from the start block 402, to a flow break block 404 which will inform the user that the interview has been terminated.

In one or more examples, if the user provides an acceptable response to the questions initiated by the chatbot 208 at start block 402, then the start block 402 can transition the conversation to the next block in the tree, which can be represented by a regular block 406. Each regular block 406 in the business logic tree 400 can represent a specific topic or part of a conversation that would make up the body of an interview. For instance, in one or more examples, after initiating the conversation at start block 406, the chatbot 208 can transition to a block 406 configured to ask the applicant about their age. In one or more examples, the prompt associated with the block 406 for age can be configured to ask the applicant “Are you over 18 years old?” In one or more examples, the prompt 408 associated with the regular block 406 for age can expect a positive intent (i.e., the user saying some form of “yes”), a negative intent (the user saying some form of “no”) or a numerical intent (the user saying their actual age, for instance, “I'm 41 years old.) In one or more examples, if the user replies “no” or in the negative, then the business tree logic can move to a flow break block 404, wherein the chatbot 208 will terminate the interview. Otherwise, if the user's age is determined to be over 18, either by them stating yes, or by stating an age that is over 18, then the business logic tree 400 will store the data in memory (for later review by an HR professional or other staffing entity) and move to the next regular block in the tree.

In one or more examples, a regular block 406 can have the option of transition to one of multiple other regular blocks 406 based on the answer given by a user in response to the prompt associated with that block. For instance, if a regular block 406 through its prompt receives information from the user that is stored as part of the prompt, then based on the answer, the business logic tree 400 can transition to one of a choice of multiple blocks, based on the answer provided by the user. In this way, the business logic tree 400 can remain flexible to the user's conversation and transition the conversation in a manner that is commensurate with a user's responses to the questions posed to them at each block in the conversation.

In one or more examples, a particular block 406 can also include one or more block skip conditions, that instruct the chatbot 208 to skip over certain blocks in the business logic tree 400. For instance, if a particular block is configured to asking the use about a skill, then the block can remain active (i.e., remain as part of the conversation) if the business logic tree 400 knows that (1) this skill is required by the job and (2) the business logic tree 400 does not yet know if the person has that skill. If either (1) or (2) or not true, then the chatbot 208 should skip the block associated with that skill. Finally, the business logic tree 400 can also include an end block 408 that is configured to terminate the interview with the client when the interview has concluded.

The business logic tree 400 and its associated data structures (i.e., blocks 402, 404, 406, and 408) can be configured to solve issues associated with operating a chatbot configured to operate in a computing environment. For instance, by implementing a chatbot in a computing environment, one of the fundamental drawbacks is that the chatbot may come off as robotic or in other words interact with a user in a manner that is not human-like, thus providing the user of the chatbot with a sub-optimal experience. However, the business logic tree 400 (and the process of generating the tree described in further detail below) can be configured to solve a problem that is unique to implementing a computer-based solution to interviewing and screening applicants: making the chatbot indistinguishable from a human interviewer.

In one or more examples, the business logic tree 400 described above with respect to FIG. 4 can be generated in a manner that is responsive not only to the requirements of the position that the interview is being used to screen candidates for, but also responsive to the skills and experiences of the user as expressed in a curriculum vitae (CV), in a manner that is similar to how a human would conduct an interview. A human would formulate an interview with a candidate based not only on the skills that the job requires but would also formulate questions based on a given candidates list of known skills and experience. In one or more examples, the business logic tree 400 can be constructed to replicate the manner in which a human would conduct the interview, but also solve a problem that is unique to conducting the interview using a computer, mainly that the interaction with the user should not be robotic or repetitive as often is the case when attempting to replicate a human experience using a machine.

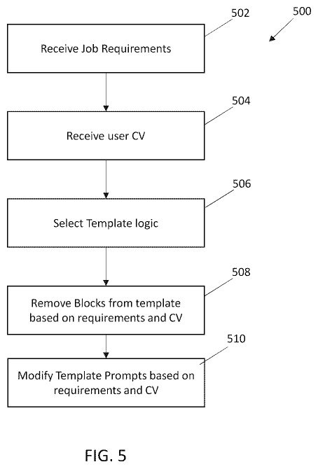

FIG. 5 illustrates an exemplary process for generating a business logic decision tree according to examples of the disclosure. In one or more examples, the process 500 of FIG. 5 can be configured to generate a business logic tree that is responsive to the context of the interview taking place. In other words, the business logic tree generated by the process 500 can be responsive to not only the requirements of the position to be filled, but also the qualifications of the applicant, so that the interview is both efficient (i.e., taking the least amount of time possible) but is also structured in a manner that is conducive to extracting the information for a candidate (i.e., user) necessary to determine whether they are suited for the position that they are interviewing for. Thus, in one or more examples, the process 500 can begin at step 502, wherein the job requirements associated with the position that interview is to be conducted for is received by the system 200 of FIG. 2. In one or more examples, the job requirements received at step 502 can be received by a staffing agency or client of a staffing agency interacting with a user-interface for the system 200 that allows the user to enter the specific requirements associated with a job. Additionally, or alternatively, the staffing agency or client can provide the system with a document or other list of the specific qualifications required for the job. In one or more examples, the job requirements can include such information as location of the job, the hours needed, the schedule an employee is expected to work, the specific skills needed for the job, the compensation associated with the job, and any other details that might be germane to finding a suitable candidate for the open position.

In one or more examples, once the job requirements for the position have been received at step 504, the process 500 can move to step 504 wherein a user's (i.e., the interviewees) CV can be received. In one or more examples, the term CV can also include any list of qualifications possessed by the user. In one or more examples, at step 504, the user can be prompted via the computing system itself to enter specific information regarding their skills and experience.

In one or more examples, once the job requirements and user's CV are received at step 502 and 504 (steps 502 and 504 can be conducted in any order), the process 500 can move to step 506 wherein a business logic tree template can be selected based on the received job requirements and CV. In one or more examples, the system 200 can store a plurality of business logic tree templates in a memory associated with the system. Based on the job requirements and the CV received at steps 502 and 504, at step 506, the process 500 can select one of the plurality of templates to use as the foundation for generating a final business logic tree 400 that is responsive to the context in which the interview is taking place (i.e., the specific job requirements and qualifications of the interviewee). For instance, if the requirements for a particular job, and the user's qualifications implicate a blue-collar job (i.e., a job that requires physical labor), then the process 500 can select a template that is associated with physical labor jobs. For instance, the template would include questions about the physical capabilities of the applicant, such as their ability to lift heavy objects or other physical conditions that may be necessary to successfully perform the requirements associated with the position being interviewed for. Likewise, if the context implicates a white-collar job (i.e., a job that requires a specific education and/or does not require physical labor) then the process 500 can select a different template that is commensurate with white collar jobs.

In one or more examples, a given template selected at step 506 can include any possible questions associated with the types of jobs associated with the template. However, the template itself may contain many questions that may not be necessary or may formulate questions in a manner that ignores the context of the interview, and thus if the template itself were executed to guide the flow of the interview, then the user experience would not be optimal because the user may be asked questions that are irrelevant to the job posting, or maybe asked questions that are obvious or redundant in light of the applicants qualifications as found in their CV. Thus, in one or more examples, once the template has been selected at step 506, the process 500 can move to step 508 wherein the business logic tree template can be pruned so as to match the context in which the template is being used (i.e., the job requirements and the user's qualifications).

In one or more examples, “pruning” a tree can include removing blocks and branches (i.e., connections between blocks) based on the context of the interview. In one or more examples, the process 500 can utilize one or more business rules to eliminate portions of the business logic tree 400 that could cause the interview flow to take a detour onto topics that may be irrelevant or unnecessary given the context of the interview. In one or more examples, once the context of the interview is ascertained at steps 502 and 504, many portions of the template selected at step 506 (i.e., branches of the tree) may be removed thereby reducing the possibility of the business logic tree 400 misclassifying the user's answers. For instance, if the job is located in a rural area as expressed in the job requirements received at step 502, then at step 508, questions regarding access to subway or other public transportation mechanisms associated with an urban environment may be removed from the template to create a business logic tree that is specific to the position being hired for and the user interviewing for the position. In this way, certain blocks can be removed from the template so that they will not be accidently triggered during the interview process and cause the interview to veer into a direction that does not make sense given the context of the interview.

Even after removing blocks and branches of the template, the content of the conversation itself may not be fully responsive to the context of the interview. For instance, the prompts associated with each of the blocks may not be tailored to be responsive to the context of the conversation. Thus, in one or more examples, once the blocks have been removed from the business logic tree 400 based on the context of the interview, the prompts associated with the remaining blocks, and other data associated with the block, may be modified by the context of the interview at step 510. Returning to the examples of FIG. 2, the system 200 can apply a HR specific intelligence process 216 that uses the context of the interview provided by CV 212 and 214 so as to input data into the business logic 210 to modify the prompts and data associated with each block of the tree to make them responsive to the context of the interview. For instance, if a particular block is configured to ask the user about certain skills, then in one or more examples, at step 510, the prompts associated with the skills block can be modified to ensure that the block asks questions to the user in manner that is appropriate for the context of the interview. For instance, if there are five skills to be asked about within a given block, but the HR specific intelligence knows that three of those skills are correlated to one another, then in one or more examples, the HR specific intelligence 216 can modify the prompts of the given block to ask the user about those skills in a manner that takes the correlation into account. Thus, rather than ask the user about each of the five skills sequentially, the HR specific intelligence may modify the prompt such that the user is asked about one of those skills, and if the user answers in the affirmative, then it can skip asking about the skills that are correlated with the skill being asked about. In this way, at step 510, the HR specific intelligence allows for a more responsive and optimal conversation (i.e., human-like) within the bounds of business logic tree established for the specific context of the interview. In one or more examples, the HR intelligence operating at step 510 can modify the blocks (without adding or removing blocks) to take into account the skill ontologies about the client and the user to improve the flow of the conversation without impacting the business logic itself.

The business logic tree generated above with respect to FIG. 5 can provide a flow to the conversation between the user 202 and the chatbot 208, by dictating the ordering of questions or topics, and by providing specific wording of questions that take into account not only the CV of the user 212 but also the position requirements 214 that are set by the client seeking to fill a specific job position. However, in one or more examples, the user themselves may interact with the chatbot in a manner that can interrupt or break the flow that has been established by the business logic tree 210. For instance, if the chatbot 208 executing the conversation is currently asking about relocation, for instance by asking “Are you okay to relocate?,” the user instead of answering the question in an expected manner (i.e., yes or no) may instead reply by stating “it depends on how much you are paying,” which can interpreted as an implied question, asking about the salary or pay of the job being interviewed for. A human interviewer, would be able to field this break from the contextual flow of the conversation, by diverting the conversation to pay in manner commensurate with the user's question, for instance by answering “this job pays $20 per hour, is that a level of pay that would consider relocating for?” However, the chatbot 208, sticking rigidly to the business tree logic 210, may not be at a point in the tree where pay is discussed, or may not even have one or more blocks in the tree dedicated to discussing pay. If the chatbot 208 doesn't respond to the user's detour, this can be suboptimal, because the chatbot 208 would appear robotic and not mimic a human-like interview experience.

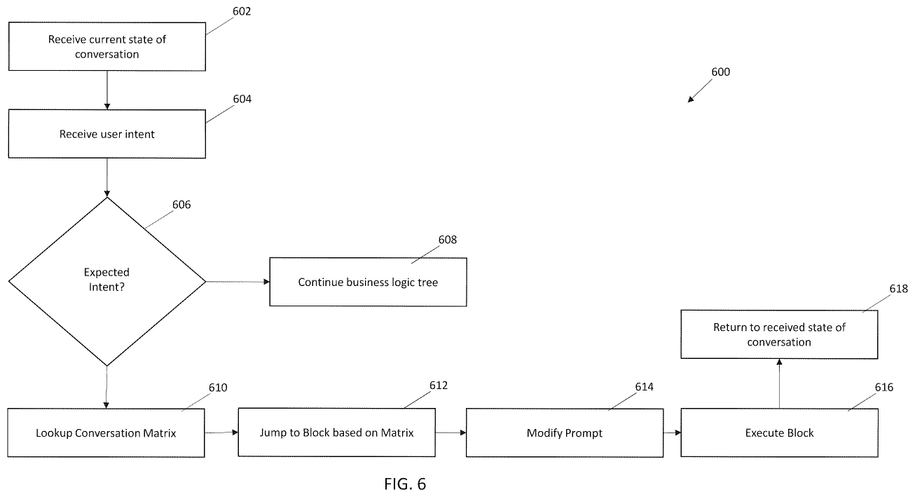

Thus, in one or more examples, the business logic 210 can have a contextual intelligence process 218 applied to it, in order to handle detours or interrupts to the conversation flow provided by the business logic 210. FIG. 6 illustrates an exemplary process for applying contextual intelligence to a business logic tree according to examples of the disclosure. In one or more examples, the process 600 can begin at step 602, wherein the contextual intelligence process 218 receives the current state of the conversation. In one or more examples, the information of the current state of the conversation can include the specific block in the business logic tree 210 that is being processed (i.e., what question or subject is being discussed currently with the user). Once the current state of the conversation is received at step 602, the process 600 can move to step 604 wherein the user's intent (i.e., the classification of the intent) from the comprehension engine 206 received. In one or more examples, the user's intent classification can include the interpretation of the user's response to a specific question asked by the chatbot 206 based on the current state of the business logic 210.

In one or more examples, once the user's intent is received from the comprehension engine 206 at step 604, the process 600 can move to 606 wherein a determination is made as to whether the received user intent is within the expected intents of the block currently being processed by the business logic tree 210. For instance, using the example above, if the chatbot 208 is currently discussing the candidate's (i.e., user's) ability or willingness to relocate, then the expected intents to that question can be as simples as “yes” or “no.” Thus, in one or more examples, if the intent received at step 604 is within the expected intents of a block (as defined by the block's prompt) then the process 500 can move to step 608 wherein the business logic tree 210 continues with the conversation in the expected flow of the conversation as determined by the configuration and placement of the blocks of tree. In other words, the business logic tree 210 can move to the next block in the conversation.

If, however, at step 606, the received intent is not within the expected intents for the block, then in one or more examples, the process 600 can move to step 610 wherein a lookup table (i.e., matrix) is consulted to determine how to handle the unexpected intent. In one or more examples, a matrix can include represent a lookup table that includes rows of questions and columns of intents. Each element of the matrix can include an action to take for a particular question and the associated intent. Using the example above, if the question is about relocation, and the user intent implicates a question about pay, then at step 610, the matrix element found at the “relocation” and “pay” can be consulted by the process 600 to determine how the business logic tree 210 should be parsed based on the unexpected user response. Thus, once the matrix element associated with the current state of the conversation and the received user intent is consulted, in one or more examples the process 600 can move to step 612 wherein the business logic tree 210 jumps to the block associated with the matrix element. Thus, using the example above, a question by the user about pay in response to the chatbot's question about relocation, can cause the business logic tree to jump to the block in the conversation associated with pay.

In one or more examples, once the process 600 jumps to the block implicated by the matrix at step 612, the process 600 can move to step 614 wherein the prompt associated by the block is modified to take into account the current context of the conversation. For instance, using the example above, if the jump to the pay block was triggered by a question regarding relocation, then in one or more examples, rather than just stating what the pay is for the job, the prompt can be modified at step 614 so as to state the pay in the context of the conversation, for instance by stating “the pay is $20 per hour, would you willing to relocate at this pay level?” Thus, rather than robotically stating the pay, the process 600 can modify the prompt at step 614 to state the pay in a manner that is contextually relevant to the way in which the pay question was introduced into the conversation by the user.

Once the prompt has been modified at step 614, the process 600 can move to step 616 wherein the block (with the modified prompt) is executed. In other words, the chatbot 208 can execute the block that is now being processed (due to the instructions from the matrix at step 612) based on the modified prompt so as to adapt the conversation between the chatbot 206 and the user 202 and make the conversation contextually relevant. Once the block is executed at step 616, the process 600 can move to step 618 wherein the conversation is returned to its previous state before the unexpected intent from the user was received. In one or more examples, by jumping back to the previous state of the conversation, the conversation can be continued after experience the detour caused by the user so as to ask the user questions needed to complete the interview in the process. In one or more examples, prior to jumping back to the previous state of the conversation at step 618, the business logic tree can be modified to account for the detour in the conversation caused by the user. For instance, using the example above, if the detour caused the chatbot to discuss pay earlier than it normally would have in the conversation, then the business logic tree 210 can be modified to ensure that pay is not again discussed (i.e., skipping the pay block when it occurs in the tree).

Returning to the example of FIG. 2, once the business logic tree 210 informs the chatbot 208 what to say to the user, the chatbot can transmit a dialogue or message to user (using either text or speech) reflecting what the business logic tree 210 has instructed the chatbot 208 to say. In one or more examples, prior to transmitting the chatbot's text to the user, a speech adjustment process 220 can be applied to the chatbots text to modify the speech so that the speech is less robotic and responsive to the user's attitude. For instance, in one or more examples, the adjustments of process 220 can include detecting the attitude of the user and adjusting the speech to make it more apologetic or casual if it is detected that the user is answering in a hostile manner (based on the classification of the user's intent at the comprehension engine 206). For instance, if the user seems hostile to the chatbot 206, then the adjustment process 220 can modify the chatbot's speech to say something more apologetic such as “we are really sorry, but we need to collect this information.”

In one or more example, additionally or alternatively to adjusting the speech based on the user's detected attitude, the adjustment process 220 can also modify the chatbot speech to avoid repetition. For instance, the adjustment may include rewording questions and answers provided by the chatbot 206 to avoid sounding repetitive so as to mimic how a human would sound in a normal conversation. Finally, once the speech has been adjusted by adjustment process 220, the output of the speech adjustment process 220 can be transmitted to translation engine 222, which can translate the speech into the language spoken by the user. For instance, in one or more examples, the translator 222 can translate the text or speech from the chatbot into the language provided to translator 204 from the user, thereby ensuring that the user can interact with the chatbot in their preferred language.

In one or more examples, the system 200 can include a Full-state Undo feature 224 which can allow for the user (by clicking on a button from a graphical user interface) to undo prior responses given to the chatbot 208, and revisit previously asked questions so as to modify their response. For instance, if a user clicks a button, then the previous response can be deleted, and the business logic tree 210 can return to a previous state before the user had provided their response, thus allowing the user to provide a different answer to a previously asked question. Alternatively, or additionally, rather than click the button, the full state undo feature 224 can be initiated by the content of the user's speech (for instance if they said, “I'd like to correct a previously given answer.”) In one or more examples, the undo feature 224 can be selectively allowed, so that in some instance the user may not be able to correct a previously given answer, so that it can prevent the user from trying to re-formulate answers to the chatbot in hopes of getting selected for a further interview.

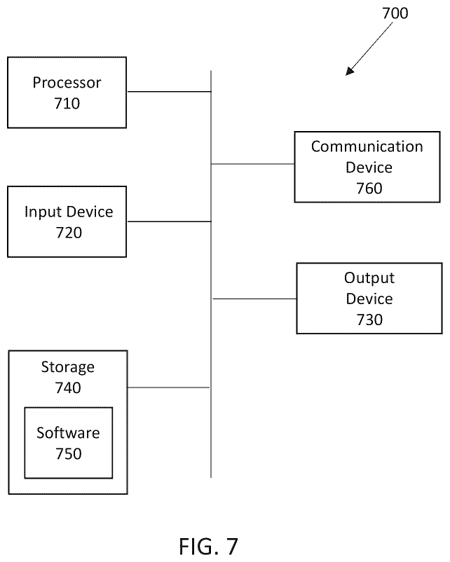

FIG. 7 illustrates an example of a computing system 700, in accordance with some embodiments, that can be used for one or more components of system 200 of FIG. 2. System 700 can be a computer connected to a network. System 700 can be a client or a server. As shown in FIG. 7, system 700 can be any suitable type of processor-based system, such as a personal computer, workstation, server, handheld computing device (portable electronic device) such as a phone or tablet, or dedicated device. The system 700 can include, for example, one or more of input device 720, output device 730, one or more processors 710, storage 740, and communication device 760. Input device 720 and output device 730 can generally correspond to those described above and can either be connectable or integrated with the computer.

Input device 720 can be any suitable device that provides input, such as a touch screen, keyboard or keypad, mouse, gesture recognition component of a virtual/augmented reality system, or voice-recognition device. Output device 730 can be or include any suitable device that provides output, such as a display, touch screen, haptics device, virtual/augmented reality display, or speaker.

Storage 740 can be any suitable device that provides storage, such as an electrical, magnetic, or optical memory including a RAM, cache, hard drive, removable storage disk, or other non-transitory computer readable medium. Communication device 760 can include any suitable device capable of transmitting and receiving signals over a network, such as a network interface chip or device. The components of the computing system 700 can be connected in any suitable manner, such as via a physical bus or wirelessly.

Processor(s) 710 can be any suitable processor or combination of processors, including any of, or any combination of, a central processing unit (CPU), field programmable gate array (FPGA), application-specific integrated circuit (ASIC), and a graphical processing unit (GPU). Software 750, which can be stored in storage 740 and executed by one or more processors 710, can include, for example, the programming that embodies the functionality or portions of the functionality of the present disclosure (e.g., as embodied in the devices as described above).

Software 750 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 740, that can contain or store programming for use by or in connection with an instruction execution system, apparatus, or device.

Software 750 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate or transport programming for use by or in connection with an instruction execution system, apparatus, or device. The transport computer readable medium can include, but is not limited to, an electronic, magnetic, optical, electromagnetic, or infrared wired or wireless propagation medium.

System 700 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

System 700 can implement any operating system suitable for operating on the network. Software 750 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated. For the purpose of clarity and a concise description, features are described herein as part of the same or separate embodiments; however, it will be appreciated that the scope of the disclosure includes embodiments having combinations of all or some of the features described.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. A method for implementing a computer-based chatbot to conduct an employment interview with a candidate for a position within a client organization, the method comprising:
receiving one or more requirements of the position within the client organization;
receiving from the candidate, information associated with candidate's qualifications for the position;
generating a plurality of block data structures stored in a memory, wherein the plurality of block data structures form a graph with each block data structure representing a node of the graph, wherein each block of the plurality of block data structures includes a topic data parameter and a prompt data parameter, the topic data parameter storing data associated with a topic of conversation between the chatbot and the user and the prompt data parameter storing information associated with one or more questions to ask the user pertaining to the topic data parameter; and wherein the plurality of block data structures are generated based on the received one or more requirements of the position within the client organization and the received information associated with the candidate's qualifications for the position;
transmitting a question from the chatbot to the user based on the topic data parameter and the prompt data parameter associated with a first block data structure of the plurality of block data structures;
receiving at the chatbot, one or more responses to the transmitted question from the user;
determining one or more intents of the one or more responses from the user; and
transmitting a question from the chatbot to the user based on the topic data parameter and the prompt data parameter associated with a second block data structure of the plurality of block data structures; wherein the second block data structure is selected based on the determined one or more intents of the one or more responses from the user.

2. The method of claim 1, wherein generating the plurality of block data structures includes selecting a template from a plurality of templates based on the received one or more requirements of the position, wherein each template includes one or more pre-defined block data structures.

3. The method of claim 2, the method comprising removing one or more pre-defined block data structures from the plurality of block data structures of the selected template based on the received one or more requirements of the position and the received information associated with the candidate's qualifications for the position.

4. The method of claim 3, the method comprising modifying one or more prompts of the plurality of block data structures based on the received one or more requirements of the position and the received information associated with the candidate's qualifications for the position.

5. The method of claim 1, wherein the method comprises comparing the determined one or more intents of the one or more responses from the user to a list of one or more expected intents associated with the first block data structure.

6. The method of claim 5, wherein the method comprises if the determined one or more intents of the one or more responses from the user do not match the one or more expected intents associated with the first block data structure, then selecting the second block data structure based on the topic data parameter of the first block data structure and the determined one or more intents.

7. The method of claim 6, wherein the method comprises modifying the prompt data parameter of the second block data structure based on the topic data parameter of the first block data structure and the determined one or more intents of the one or more responses from the user.

8. The method of claim 1, wherein transmitting a question from the chatbot to the user based on the topic data parameter and the prompt data parameter associated with a first block data structure of the plurality of block data structures comprises determining an attitude of the user based on the one or determined intents of the user and modifying the transmitted question based on the determined attitude of the user.

9. The method of claim 1, wherein determining the one or more intents of the one or more responses from the user comprises applying a machine learning classifier to the one or more responses from the user.

10. The method of claim 9, wherein the machine learning classifier is generated using a supervised training process.

11. A system for implementing a computer-based chatbot to conduct an employment interview with a candidate for a position within a client organization, the system comprising:
a memory;
one or more processors;
wherein the memory stores one or more programs that when executed by the one or more processors, cause the one or more processors to:
receive one or more requirements of the position within the client organization;
receive from the candidate, information associated with candidate's qualifications for the position;
generate a plurality of block data structures stored in a memory, wherein the plurality of block data structures form a graph with each block data structure representing a node of the graph, wherein each block of the plurality of block data structures includes a topic data parameter and a prompt data parameter, the topic data parameter storing data associated with a topic of conversation between the chatbot and the user and the prompt data parameter storing information associated with one or more questions to ask the user pertaining to the topic data parameter; and wherein the plurality of block data structures are generated based on the received one or more requirements of the position within the client organization and the received information associated with the candidate's qualifications for the position;
transmit a question from the chatbot to the user based on the topic data parameter and the prompt data parameter associated with a first block data structure of the plurality of block data structures;
receive at the chatbot, one or more responses to the transmitted question from the user;
determining one or more intents of the one or more responses from the user; and
transmit a question from the chatbot to the user based on the topic data parameter and the prompt data parameter associated with a second block data structure of the plurality of block data structures; wherein the second block data structure is selected based on the determined one or more intents of the one or more responses from the user.

12. The system of claim 11, wherein generating the plurality of block data structures includes selecting a template from a plurality of templates based on the received one or more requirements of the position, wherein each template includes one or more pre-defined block data structures.

13. The system of claim 12, wherein the one or more processors are caused to remove one or more pre-defined block data structures from the plurality of block data structures of the selected template based on the received one or more requirements of the position and the received information associated with the candidate's qualifications for the position.

14. The system of claim 13, the one or more processors are caused to modify one or more prompts of the plurality of block data structures based on the received one or more requirements of the position and the received information associated with the candidate's qualifications for the position.

15. The system of claim 11, wherein the one or more processors are caused to compare the determined one or more intents of the one or more responses from the user to a list of one or more expected intents associated with the first block data structure.

16. The system of claim 15, wherein the one or more processors are caused to if the determined one or more intents of the one or more responses from the user do not match the one or more expected intents associated with the first block data structure, then selecting the second block data structure based on the topic data parameter of the first block data structure and the determined one or more intents.

17. The system of claim 16, wherein the one or more processors are caused to modify the prompt data parameter of the second block data structure based on the topic data parameter of the first block data structure and the determined one or more intents of the one or more responses from the user.

18. The system of claim 11, wherein transmitting a question from the chatbot to the user based on the topic data parameter and the prompt data parameter associated with a first block data structure of the plurality of block data structures comprises determining an attitude of the user based on the one or determined intents of the user and modifying the transmitted question based on the determined attitude of the user.

19. The system of claim 11, wherein determining the one or more intents of the one or more responses from the user comprises applying a machine learning classifier to the one or more responses from the user.

20. The system of claim 19, wherein the machine learning classifier is generated using a supervised training process.

21. A non-transitory computer readable storage medium storing one or more programs for implementing a computer-based chatbot to conduct an employment interview with a candidate for a position within a client organization, for execution by one or more processors of an electronic device that when executed by the device, cause the device to:
receive one or more requirements of the position within the client organization;
receive from the candidate, information associated with candidate's qualifications for the position;
generate a plurality of block data structures stored in a memory, wherein the plurality of block data structures form a graph with each block data structure representing a node of the graph, wherein each block of the plurality of block data structures includes a topic data parameter and a prompt data parameter, the topic data parameter storing data associated with a topic of conversation between the chatbot and the user and the prompt data parameter storing information associated with one or more questions to ask the user pertaining to the topic data parameter; and wherein the plurality of block data structures are generated based on the received one or more requirements of the position within the client organization and the received information associated with the candidate's qualifications for the position;
transmit a question from the chatbot to the user based on the topic data parameter and the prompt data parameter associated with a first block data structure of the plurality of block data structures;
receive at the chatbot, one or more responses to the transmitted question from the user;
determining one or more intents of the one or more responses from the user; and
transmit a question from the chatbot to the user based on the topic data parameter and the prompt data parameter associated with a second block data structure of the plurality of block data structures; wherein the second block data structure is selected based on the determined one or more intents of the one or more responses from the user.

22. The non-transitory computer readable storage medium of claim 21, wherein generating the plurality of block data structures includes selecting a template from a plurality of templates based on the received one or more requirements of the position, wherein each template includes one or more pre-defined block data structures.

23. The non-transitory computer readable storage medium of claim 22, wherein the device is caused to remove one or more pre-defined block data structures from the plurality of block data structures of the selected template based on the received one or more requirements of the position and the received information associated with the candidate's qualifications for the position.

24. The non-transitory computer readable storage medium of claim 23, wherein the device is caused to modify one or more prompts of the plurality of block data structures based on the received one or more requirements of the position and the received information associated with the candidate's qualifications for the position.

25. The non-transitory computer readable storage medium of claim 21, wherein the device is caused to compare the determined one or more intents of the one or more responses from the user to a list of one or more expected intents associated with the first block data structure.

26. The non-transitory computer readable storage medium of claim 25, wherein the device is caused to if the determined one or more intents of the one or more responses from the user do not match the one or more expected intents associated with the first block data structure, then selecting the second block data structure based on the topic data parameter of the first block data structure and the determined one or more intents.

27. The non-transitory computer readable storage medium of claim 26, wherein the device is caused to modify the prompt data parameter of the second block data structure based on the topic data parameter of the first block data structure and the determined one or more intents of the one or more responses from the user.

28. The non-transitory computer readable storage medium of claim 21, wherein transmitting a question from the chatbot to the user based on the topic data parameter and the prompt data parameter associated with a first block data structure of the plurality of block data structures comprises determining an attitude of the user based on the one or determined intents of the user and modifying the transmitted question based on the determined attitude of the user.

29. The non-transitory computer readable storage medium of claim 21, wherein determining the one or more intents of the one or more responses from the user comprises applying a machine learning classifier to the one or more responses from the user.

30. The non-transitory computer readable storage medium of claim 29, wherein the machine learning classifier is generated using a supervised training process.
